(19) United States
(12) Patent Application Publication
(10) Pub. No.: US 2004/0264825 A1
(43) Pub. Date: Dec. 30, 2004

(54) Superfinishing machine, superfinishing method, rolling element and rolling bearing

(75) Inventors: Yuko Kamamura, Kanagawa (JP); Yoshirou Ide, Kanagawa (JP); Chiharu Karita, Kanagawa (JP); Iori Nakahara, Kanagawa (JP); Takashi Murai, Kanagawa (JP); Osamu Fujii, Kanagawa (JP); Hiroki Mizuno, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD.

(21) Appl. No.: 10/820,002

(22) Filed: Apr. 8, 2004

(30) Foreign Application Priority Data
Apr. 9, 2003 (JP) P.2003-105275
Feb. 24, 2004 (JP) P.2004-047764

(51) Int. Cl. F16C 33/34; F16C 33/58

(52) U.S. Cl. 384/568

(57) ABSTRACT

Driving rollers 2, 3 which rotate in the same direction are arranged in parallel to each other. A plurality of convex portions 5a, 5b, 5c having different radii of curvature Rr1, Rr2 and Rr3 are formed along the axial direction at opposing positions on the driving rollers 2, 3. A rolling element 4 which is fed into the gap between the driving rollers 2, 3 and rotated is moved along tracks having different radii of curvature Rw1, Rw2 and Rw3 in the axial direction. There is provided a superfinishing grindstone 6 which is pressed on the rolling surface of the rolling element 4 moving on tracks having different radii of curvature to superfinish the rolling surface of the rolling element 4.

### BACKGROUND OF THE INVENTION

The present invention relates to a superfinishing machine and method for superfinishing the periphery of a columnar work to be used, e.g., as the cylindrical roller for rolling bearing, a superfinished rolling element, and a rolling bearing comprising same.

In general, a rolling element to be used as a cylindrical roller for rolling bearing is ground. The roller thus ground is then subjected to superfinishing on the rolling surface thereof, which is the outer periphery thereof.

As a machine for superfinishing, there is heretofore used one which allows a pair of driving rollers to rotate in the same direction with a rolling element put therebetween so that the rolling element is rotated while a superfinishing grindstone is pressed on the rolling surface of the rolling element with a predetermined pressure to superfinish the rolling surface of the rolling element (see, e.g., Patent Reference 1). As such a type of superfinishing machine, there is also known one which machines an arc-shaped rolling surface.

[Patent Reference 1] JP-A-2002-86341

In recent years, a long life is demanded to a rolling bearing so as to resist a wide range of load. To this end, it is required that the rolling element to be incorporated in the rolling bearing have a generating line having a crowning (fall) allowing gradual change of radius of curvature.

The aforementioned related art techniques are capable of machining a rolling element having a rolling surface the generating line of which is straight-shaped or merely a shape composed of arcs but are not capable of machining a rolling element having a crowning allowing gradual change of radius of curvature, making it difficult to produce a bearing having a long life so as to resist a wide range of load.

### SUMMARY OF THE INVENTION

An aim of the present invention is to provide a superfinishing machine and method capable of providing a columnar work with a peripheral generatrix having a crowning allowing gradual change of radius of curvature, a superfinished rolling element and a rolling bearing comprising such a rolling element.

The superfinishing machine according to the invention for accomplishing the aforementioned object of the invention is a superfinishing machine having a pair of driving rollers disposed in parallel to each other which rotate in the same direction to rotate a columnar work fed into the gap therebetween and a superfinishing grindstone which is pressed on, in which the work being rotated by these driving rollers, wherein the pair of driving rollers each have a plurality of axially continuous contact portions having different contours of axially taken section provided at opposing positions and the work is superfinished on the periphery thereof while being moved along the contact portions with the superfinishing grindstone pressed on the periphery of the work.

In accordance with the superfinishing machine thus arranged, the work is superfinished on the periphery thereof while being moved along the contact portions with the superfinishing grindstone pressed on the periphery of the work, making it possible to machine a work having a crowning allowing continuous change of radius of curvature. This is because when the plurality of contact portions have the same contour of axially taken section, the work moves on the same track between the opposing pair of contact portions while when the plurality of contact portions have different contours of axially taken section, the work moves along different tracks between the opposing pair of contact portions. This is also because when the work is moved along different tracks, the work can be provided with peripheries different from contact portion to contact portion. In other words, in order to machine the object into a gentle shape, the work is passed through the gap between contact portions having a gentle shape with a grindstone pressed on the work. In order to machine the object into a partially steep shape, the work is moved along a steep slope, i.e., passed through the gap between contact portions having a steep slope with a grindstone pressed on the work. By combining various process through the gap between contact portions, the work can be provided generally with a desired shape (e.g., crowning represented by a logarithmic shape having a gentle slope in central portion and steeply sloped ends). In this manner, a columnar work having a long life so as to resist against a wide range of load can be obtained.

The contour in axially taken cross-section of the plurality of contact portions preferably have different radii of curvature. Examples of the contour in axially taken cross-section of the plurality of contact portions include convex or concave arc having different radii of curvature, and straight form (i.e., infinite radius of curvature). In accordance with the superfinishing machine thus arranged, the work can be superfinished on the periphery thereof while being moved along tracks having different radii of curvature. Accordingly, a curve approximated by a combination of arcs having different radii of curvature can be formed on the periphery of the work, making it possible to machine a work having a crowning allowing gradual change of radius or curvature. In this manner, a columnar work having a long life so as to resist against a wide range of load can be obtained.

Examples of the columnar work include rolling members (e.g., cylindrical roller, long roller, needle roller) such as those to be incorporated in bearing, those to be incorporated in linear guide and those for traction drive and also inner ring, outer ring and cam follower for color-free cylindrical bearing.

In order to accomplish the aforementioned aim, the superfinishing method according to the invention may involve machining with an ordinary superfinishing grindstone or an elastic grindstone. The use of an elastic grindstone having a lower modulus of elasticity than ordinary superfinishing grindstone makes it possible to make the connection between the various approximated arcs more gradual. The Young's modulus of elasticity of the elastic grindstone is preferably from 500 Mpa to 5,000 Mpa.

The superfinishing method according to the invention comprises superfinishing a columnar work whose peripheral generatrix is previously worked in a straight or crowning form.

The columnar work according to the invention has a superfinished periphery machined by the aforementioned superfinishing method.

The rolling element according to the invention has a superfinished rolling surface machined by the aforementioned superfinishing method.

The rolling bearing according to the invention comprises the aforementioned rolling element incorporated between an inner ring and an outer ring.

The superfinishing method according to the invention for accomplishing the aforementioned aim comprises superfinishing the periphery of a columnar work with a superfinishing grindstone pressed on the periphery of the work while rotating the work, wherein the work is moved along tracks having different radii of curvature while being rotated and the superfinishing grindstone is pressed on the work during the movement to form arcs having different radii of curvature on the periphery thereof.

In accordance with the aforementioned superfinishing method, the work is moved along tracks having different radii of curvature with a superfinishing grindstone pressed thereon while being rotated to form arcs having different radii of curvature, making it possible to form a curve formed by arcs having different radii of curvature on the periphery thereof. Further, a work having a crowning allowing gradual change of radius of curvature can be machined, making it possible to obtain a columnar work having a long life so as to resist against a wide range of load.

The use of a grindstone having a lower elasticity than ordinary superfinishing grindstone as a superfinishing grindstone to be used in the superfinishing method according to the invention makes it possible to make the connection between the various approximated arcs more gradual.

The rolling element according to the invention has a curve approximated by arcs having different radii of curvature formed on the rolling surface thereof, the curve having a continuous and gradual change of radii of curvature over connections.

The rolling bearing according to the invention comprises a rolling element incorporated between an inner ring and an outer ring, the rolling element having a curve approximated by arcs having different radii of curvature formed on the rolling surface thereof, the curve having a continuous and gradual change over connections.

### BRIEF DESCRIPTION OF THE DRAWINGS

FIG. 1 is a cross sectional view illustrating the configuration of a superfinishing machine showing an embodiment of implementation of the invention;

FIG. 2 is a top view of driving roller illustrating a process for superfinishing a rolling element using, a superfinishing machine;

FIG. 3 is a cross sectional view taken on line A-A in FIG. 2, which illustrates a process for superfinishing a rolling element using a superfinishing machine;

FIG. 4 is a cross sectional view taken on line B-B in FIG. 2;

FIG. 5 is a cross sectional view taken on line C-C in FIG. 2;

FIG. 6 is a side view illustrating a superfinished rolling element;

FIG. 7 is a graph illustrating the shape of curve on the rolling surface of a rolling element;

FIG. 8 is a cross sectional view illustrating a rolling bearing comprising a rolling element formed by a cylindrical roller;

FIG. 9 is a side view illustrating a rolling element before superfinishing;

FIG. 10 is a side view illustrating a rolling element before superfinishing;

FIG. 11 is a graph for determining the shape of curve of a rolling element to be superfinished in Examples 1 and 2;

FIG. 12 is a side view illustrating the shape of the driving roller used in Example 2;

FIG. 13 is a diagram illustrating the outer shape of a rolling element superfinished in Examples 1 and 2;

FIG. 14 is a graph for determining the shape of curve of a rolling element to be superfinished in Example 3;

FIG. 15 is a side view illustrating the shape of the driving roller used in Example 3;

FIG. 16 is a graph for determining the shape of curve of a rolling element to be superfinished in Example 4;

FIG. 17 is a side view illustrating the shape of the driving roller used in Example 4;

FIG. 18 is a graph for determining the shape of curve of a rolling element to be superfinished in Example 5; and

FIG. 19 is a side view illustrating the shape of the driving roller used in Example 5.

### DETAILED DESCRIPTION OF THE PREFERRED EMBODIMENTS

Embodiments of implementation of the superfinishing machine, superfinishing method, rolling element and rolling bearing according to the invention will be described in connection with the attached drawings.

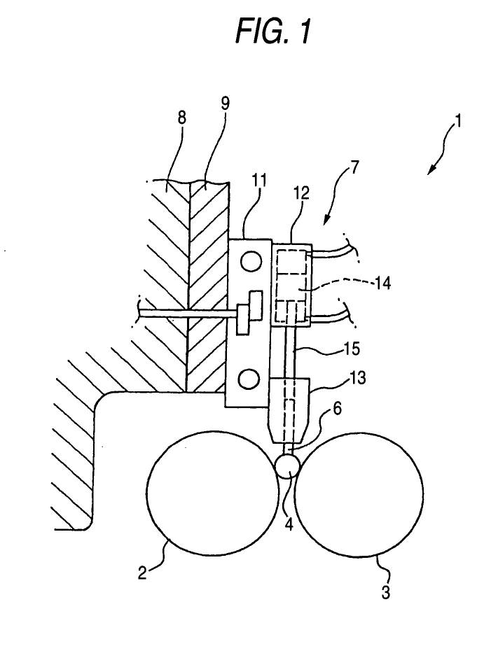

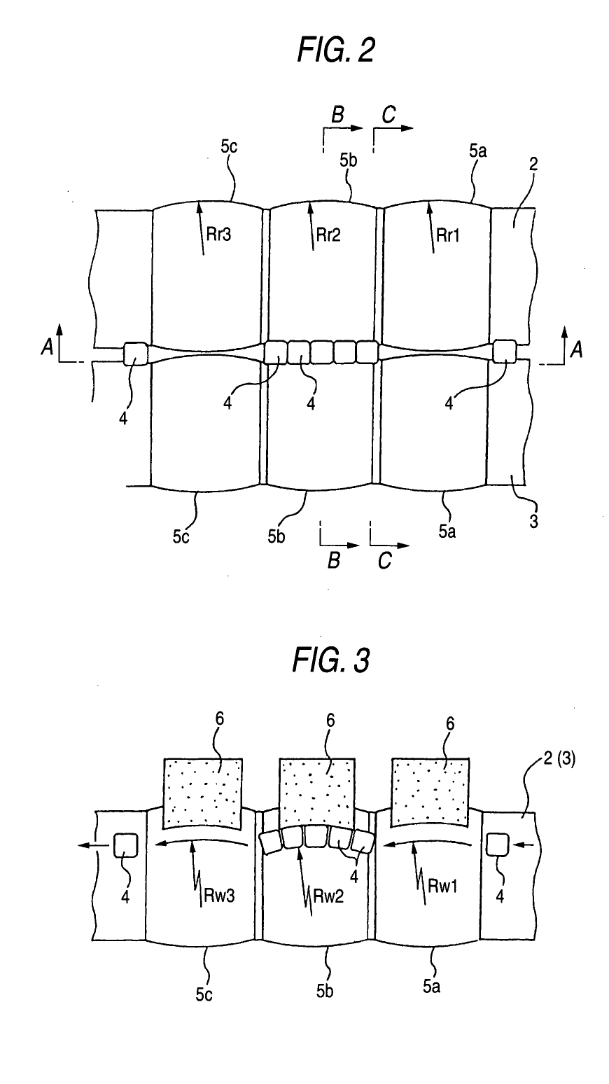

FIG. 1 is a cross sectional view of a superfinishing machine according to an embodiment of implementation of the invention, FIG. 2 is a top plan view of a driving roller illustrating a method for superfinishing a rolling element using a superfinishing machine, and FIG. 3 is a sectional view taken on line A-A in FIG. 2, which illustrates a method for superfinishing a rolling element using a superfinishing machine.

As shown in FIGS. 1 to 3, the superfinishing machine 1 comprises a pair of cylindrical driving rollers 2, 3 disposed in parallel to each other. These driving rollers 2, 3 are rotated each by a driving motor (not shown). One of the driving rollers (driving roller 2) is disposed in such an arrangement that its rotary axis extends horizontally while the other driving roller 3 is disposed in such an arrangement that its rotary axis extends obliquely to horizon at a predetermined angle. The angle of inclination of the other driving roller 3 is called through-feed angle. By providing the other driving roller 3 with a through-feed angle, a rolling element 4 which is a columnar work is given an axial feed movement. The rolling element 4 according to the present embodiment is a so-called cylindrical roller to be incorporated in bearing, etc.

The gap between the driving rollers 2, 3 is predetermined such that the rolling element 4 can be retained. A plurality of rolling elements 4 are continuously fed into the gap between the driving rollers 2, 3 from the inlet side (right side as viewed on FIGS. 2 and 3). When the driving rollers 2, 3 are rotationally driven in the same direction with the rolling element 4 retained in the gap between the driving rollers 2, 3, the rolling element 4 is fed axially along the driving roller 2 while being rotated by the frictional drive by the driving rollers 2, 3.

The driving rollers 2, 3 each have a plurality of convex portions (contact portions) 5a, 5b, 5c formed along the axial direction. These convex portions 5a, 5b and 5c have arcs having different radii of curvature.

Above the gap between the driving rollers 2, 3, a superfinishing grindstone 6 is provided each at the positions opposed to the convex portions 5a, 5b, 5c. These superfinishing grindstones 6 are pressed on the rolling surface of the rolling element 4 which is rotated in the gap between the driving rollers 2, 3.

These superfinishing grindstones 6 are each retained by a grindstone retainer 7. The grindstone retainer 7 has a main base 9 which can move in the vertical direction relative to the retainer main body 8. The main base 9 has a plurality of sub bases 11 mounted thereon.

The sub bases 11 each have a plurality of piston-cylinder mechanisms 12 for retaining the superfinishing grindstone 6 and pressing the superfinishing grindstone 6 on the rolling surface of the rolling element 4 with a predetermined pressure and a plurality of guide holders 13 for guiding the superfinishing grindstone 6 in the vertical direction and retaining the superfinishing grindstone 6.

The various piston-cylinder mechanisms 12 each use air as a driving source and have its piston 14 connected to a push rod 15 for pushing the superfinishing grindstone 6 retained in the corresponding guide holder 13 toward the rolling surface of the rolling element 4.

The angle between the straight lines connecting the center of the rolling element 4 retained in the gap between the driving rollers 2, 3 and the center of the driving rollers 2, 3 and the straight line connecting the center of the driving rollers 2, 3 is called angle of work center.

Since the driving rollers 2, 3 each have convex portions 5a, 5b, 5c provided thereon, the rolling element 4 which is fed through the gap between the opposing convex portions 5a, 5b, 5c having a radius Rr of curvature passes over the convex portions 5a, 5b, 5c.

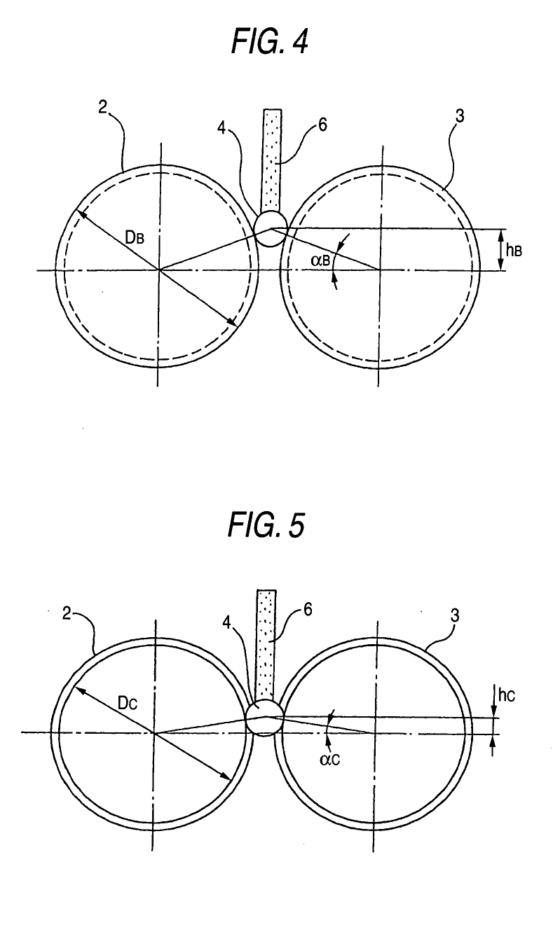

A sectional view taken on line B-B in FIG. 2 is shown in FIG. 4. A sectional view taken on line C-C in FIG. 2 is shown in FIG. 5.

As shown in FIG. 4, the work center and the angle of work center at the central portion in the convex portions 5a, 5b, 5c (diameter: DB), where the diameter of the driving rollers 2, 3 is maximum, are hB and αB, respectively. As shown in FIG. 5, the work center and the angle of work center at the end portion in the convex portions 5a, 5b, 5c (diameter: DC), where the diameter of the driving rollers 2, 3 is minimum, are hC and αC, respectively.

The convex portions 5a, 5b, 5c of the driving rollers 2, 3 have different radii of curvatures (Rr1, Rr2, Rr3).

In this arrangement, the rolling element 4, which is fed through the gap between the opposing convex portions 5a, 5b, 5c, passes over the convex portions 5a, 5b, 5c to move along the tracks having radii Rw1, Rw2 and Rw3 of curvature, respectively. Under these conditions, the superfinishing grindstone 6 having an acting surface formed along the path of the rolling element 4 is pressed on the rolling surface of the rolling element 4 so that the rolling surface of the rolling element is machined to have an arc generatrix.

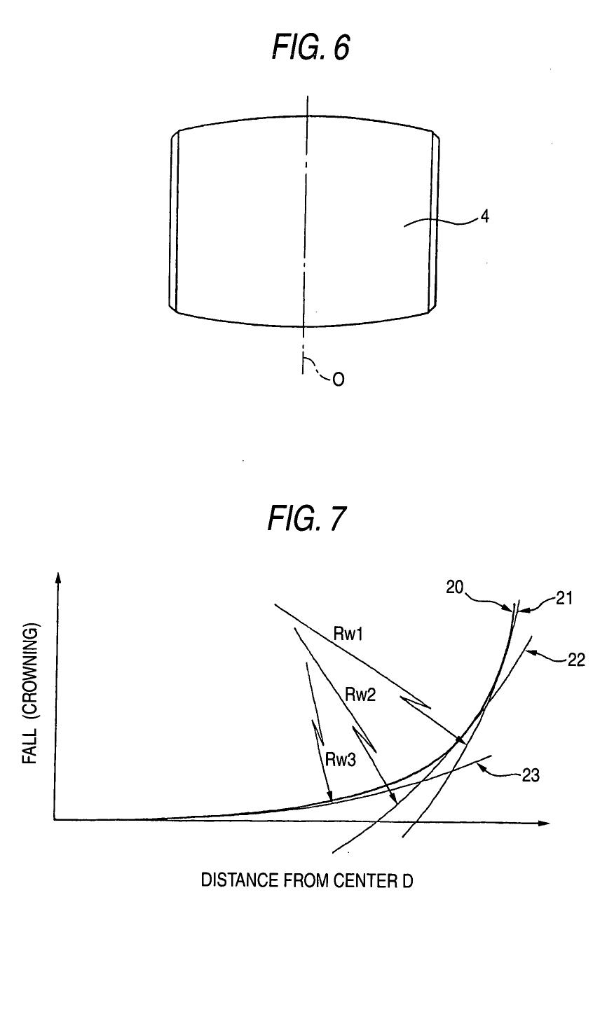

In this manner, the rolling element 4 which is passed through the gap between the various opposing convex portions 5a, 5b, 5c where it is superfinished by the superfinishing grindstone 6 has a plurality of radii Rw1, Rw2 and Rw3 of curvature in combination as shown in FIG. 6. Thus, the rolling element 4 is provided with a crowning allowing gradual change of radius of curvature.

In practice, the rolling element 4 is formed into a shape having a curve 20 formed by curves 21, 22 and 23 approximated by arcs having radii Rw1, Rw2 and Rw3, respectively, which has a gradual and continuous change over connections between the arcs, due to the elastic deformation of the rolling element 4, the superfinishing grindstone 6 or the driving rollers 2, 3 during machining, the change of contact, the shape of the acting surface of the grindstone, etc. as shown in FIG. 7.

Thus, in accordance with the present embodiment, the rolling element 4 can be passed over the convex portions 5a, 5b, 5c of the driving rollers 2, 3 with the grindstone 6 pressed on the rolling surface of the rolling element 4 to move along the tracks having radii Rw1, Rw2 and Rw3 of curvature so that the rolling surface of the rolling element 4 is superfinished. In this manner, curves 21, 22 and 23 formed by arcs having radii Rw1, Rw2 and Rw3 of curvature can be formed on the rolling surface of the rolling element 4.

In other words, a rolling element 4 having a crowning allowing gradual change of radius of curvature can be formed.

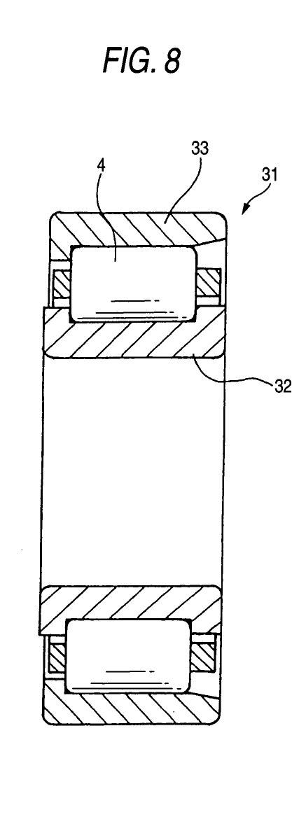

FIG. 8 illustrates a rolling bearing 31 comprising a rolling element 4 as a cylindrical roller. The rolling bearing 31 comprises a plurality of rolling elements 4 arranged circumferentially interposed between an inner ring 32 and an outer ring 33. The rolling bearing 31 comprising these rolling elements 4 disposed interposed between the inner ring 32 and the outer ring 33 can form a bearing having a long life so as to resist against a wide range of load.

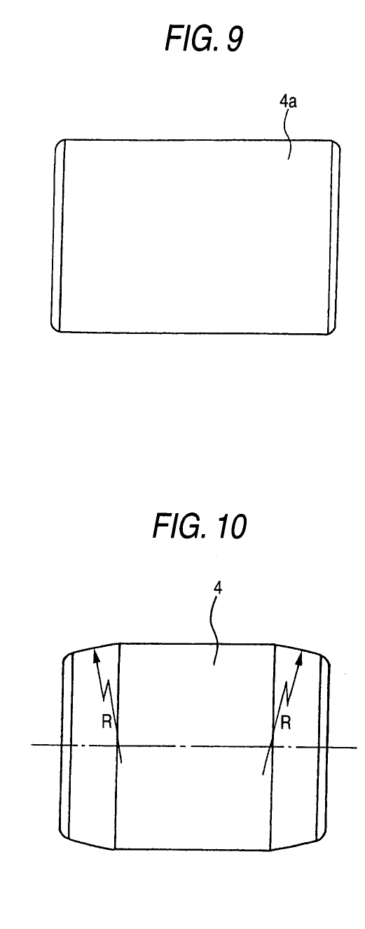

As the rolling element to be superfinished, a rolling element having an arc portion R formed in the vicinity of the end of the rolling surface thereof may as shown in FIG. 10 be used as well as a rolling element 4 having a straight-shaped rolling surface as shown in FIG. 9. The previous formation of the arc portion R makes it possible to reduce the margin at the both ends of the rolling surface and hence drastically enhance the productivity for making the rolling element 4 into the desired outer shape.

The rolling element to be superfinished may have a multistage crowning formed by two or three stages of crowning or a crowning represented by a logarithmic curve rather than crowning having a straight portion and an arc portion R. These crowning shapes may be formed by through-feed centerless grinding by which the material is ground into a straight form and subsequent grinding by a through-feed centerless grinder having a concave grindstone and a convex drum by which the rolling element is provided with an arc crowning R in the vicinity of the ends thereof. Alternatively, the rolling element may be subjected to infeed grinding by a grindstone which is previously formed into a desired shape to have an arbitrary desired shape.

The rolling element 4 which is a work is formed by forging or lathe turning, subjected to heat treatment, and then the end face and the outer periphery is ground thereof to form a column. Thereafter, the rolling element 4 may be subjected to superfinishing according to the invention directly or after being subjected to barrel finishing. Barrel finishing is advantageous for rounding off the portion around the chamfer or improving the surface conditions of chamfered portion which is not subjected to machining after heat treatment can be made. On the other hand, barrel finishing requires additional process causing extra production cost, and has the possibility that the roundness of the rolling element 4 may be deteriorated due to the process where barrel finishing is a free working with free abrasive grains. Therefore, barrel finishing may or may not be introduced.

Further, since angle of work center differs from position to position depending on the through-feed angle, in order to determine the radius of curvature of the convex portions of the driving roller corresponding to the radius of curvature of approximated arc on the rolling element 4, the geometrical relationship between the diameter of the driving rollers 2, 3 and the rolling element 4 needs to be determined on the basis of angle of work center at that position.

Moreover, it is preferred that driving rollers 2, 3 be selected which are shaped such that the diameter of the convex portions 5a, 5b, 5c is smaller in the central part thereof than that at the periphery thereof to reduce the variation of angle of work center.

In arranging convex portions 5a, 5b, 5c having different radii of curvature on the driving rollers 2, 3, a convex portion 5a having a small radius of curvature giving a large crowning may be first placed along the feed direction of the rolling element 4 followed by convex portions 5b and 5c having larger radii of curvature. On the other hand, the convex portion 5c having a great radius of curvature allowing gradual feed of the rolling element 4 may be first placed followed by the convex portions 5b and 5a having smaller radii of curvature.

The number of arcs by which the curve of the convex portions is approximated to form the rolling surface of the rolling element 4 such that crowning changes gradually is not limited to three as above but may be two or four or more.

The convex portions having different radii of curvature are described with reference to the case where these convex portions are formed on one set of driving rollers in one machine. However, in the case where two or three of these superfinishing machines are used in series, even if the radius of curvature of the convex portions on the driving rollers of each of the superfinishing machines are the same, when the rolling element is machined over driving rollers with convex portions having radii of curvature which are different as a whole, the same effect as above can be exerted.

While the present embodiment is described with reference to the case where the driving rollers are each provided with a plurality of convex portions having different radii of curvature arranged along the axial direction as contact portions, the driving roller is not limited to the aforementioned embodiment but may be arbitrarily arranged so far as a plurality of contact portions which are axially continuous and have different contours of section taken axially are provided at opposing positions. The contour of section of contact portions taken axially may be formed by an arc having a single radius of curvature and a tangent line connected to the arc or may be a combination of a plurality of arcs having different radii of curvature.

### EXAMPLE

### Example 1

A procedure of machining the rolling surface of the rolling element 4 such that it has an ideal logarithmic shape as shown in FIG. 11 as a crowning (fall) allowing gradual change of radius of curvature will be described below.

The approximation of the ideal logarithmic shape by arcs gave three arcs having curvature radii (Rw1, Rw2, Rw3) of 300 mm, 1,500 mm and 4,500 mm, respectively. The radius of curvature of the convex portions 5a, 5b, 5c of the driving rollers 2, 3 are determined from the angle of work center and the diameter of the driving rollers 2, 3 and the diameter of the rolling element 4 such that the moving tracks of the rolling element 4 have curvature radii Rw1, Rw2 and Rw3 of 300 mm, 1,500 mm and 4,500 mm, respectively. As a result, Rr1, Rr2 and Rr3 are determined to be 970 mm, 4,400 mm and 13,000 mm, respectively.

The use of the driving rollers 2, 3 having convex portions 5a, 5b, 5c having curvature radii Rr1, Rr2 and Rr3 of 970 mm, 4,400 mm and 13,000 mm, respectively, formed thereon causes the rolling element 4 to move along moving tracks having curvature radii Rw1, Rw2 and Rw3 of 300 mm, 1,500 m and 4,500 mm, respectively, through the gap between the convex portions 5a, 5b, 5c. Subsequently, the rolling surface of the rolling element 4 is superfinished by a superfinishing grindstone 6.

In the aforementioned case, the curvature radii Rr1, Rr2 and Rr3 of the driving rollers 2, 3 are determined from the geometrical relationship between the angle of work center and the diameter of the driving rollers 2, 3 and the diameter of the rolling element 4 such that the moving tracks of the rolling element 4 have curvature radii Rw1, Rw2 and Rw3 of 300 mm, 1,500 mm and 4,500 mm, respectively. As a result, Rr1, Rr2 and Rr3 are determined to be 970 mm, 4,400 mm and 13,000 mm, respectively, which are about three times the radii of curvature of the moving tracks of the rolling element 4. However, the desired radii of curvature of the driving rollers differs under different conditions.

### Example 2

While Example 1 is described with reference to the case where superfinishing is conducted using driving rollers each having convex portions corresponding to various approximated arcs provided at the respective one position, the amount of removal required at each of the approximated arcs varies in practice. The amount of removal at a large radius of curvature needs to be large. Further, since superfinishing at a small radius of curvature tends to be instable, it is sometimes preferred to employ driving rollers where the final and first convex portions have a large radius of curvature.

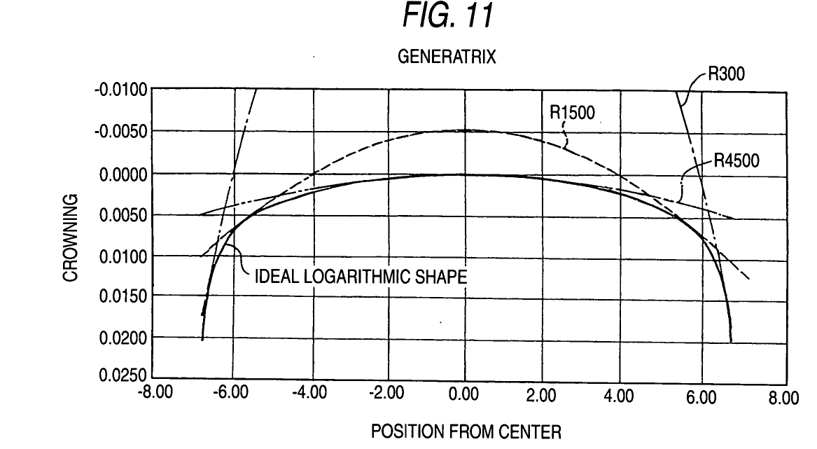

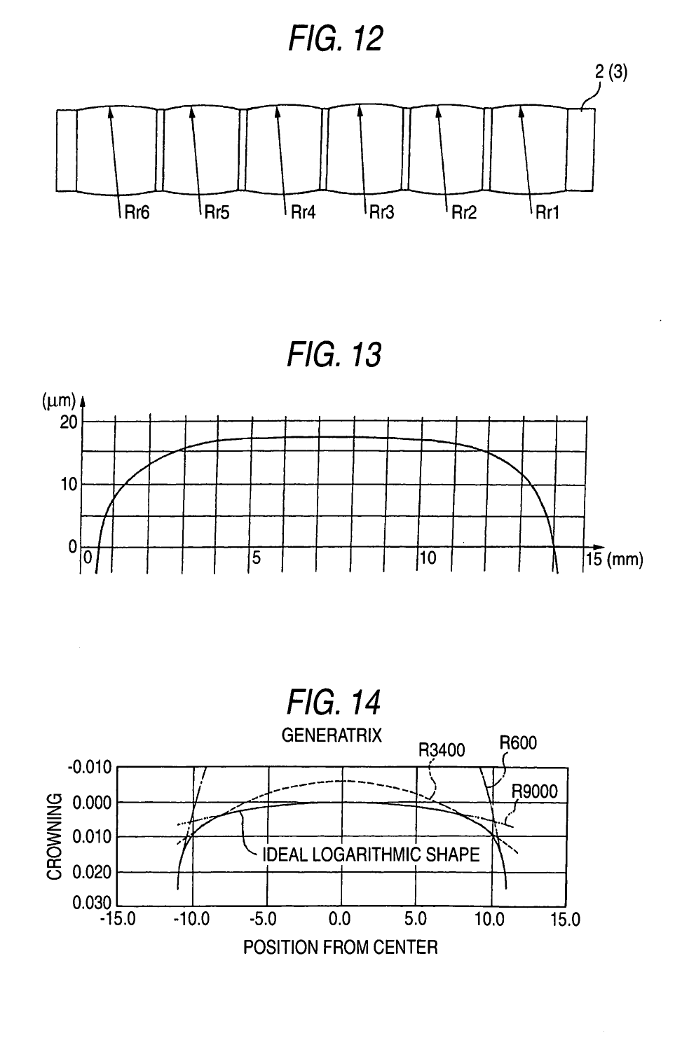

Therefore, the rolling element is superfinished by a superfinishing machine comprising driving rollers 2, 3 having six convex portions having curvature radii Rr1, Rr2, Rr3, Rr4, Rr5 and Rr6 of 13,000 mm, 13,000 mm, 970 mm, 4,400 mm, 4,400 mm and 13,000 mm, respectively, as shown in FIG. 12.

It is thus made obvious that a rolling element having a rolling surface superfinished into a shape close to an ideal logarithmic shape approximated by three arcs can be formed as shown in FIG. 13. Further, these arcs are gradually connected to each other continuously. No discontinuity is recognized.

### Example 3

A procedure of machining the rolling surface of the rolling element 4 such that it has an ideal logarithmic shape as shown in FIG. 14 as a crowning will be described below.

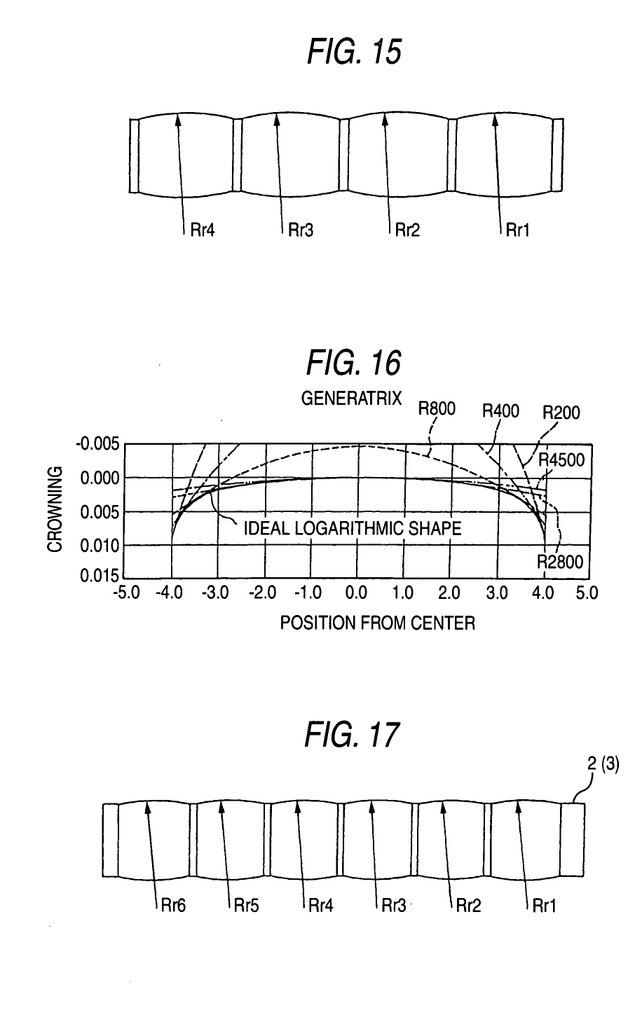

The approximation of the ideal logarithmic shape by arcs gave three arcs having curvature radii (Rw1, Rw2, Rw3) of 9,000 mm, 3,400 mm and 600 mm, respectively. Therefore, there are provided three convex portions such that the moving tracks of the rolling element 4 have curvature radii Rw1, Rw2 and Rw3 of 9,000 mm, 3,400 mm and 600 mm, respectively, as shown in FIG. 15. Further, a convex portion is provided having a moving track having a curvature radius Rw4 of 9,000 mm such that the rolling element can be finally superfinished at a large radius of curvature to stabilize superfinishing.

The radius of curvature of the convex portions of the driving rollers 2, 3 are determined from the geometrical relationship between the angle of work center and the diameter of the driving rollers 2, 3 and the rolling element 4 such that the moving tracks of the rolling element 4 have curvature radii Rw1, Rw2, Rw3 and Rw4 of 9,000 mm, 3,400 mm, 600 mm and 9,000 mm, respectively. As a result, Rr1, Rr2, Rr3 and Rr4 are determined to be 280,000 mm, 20,000 mm, 2,600 mm and 280,000 mm, respectively.

The use of the driving rollers 2, 3 having a plurality of convex portions having curvature radii Rr1, Rr2, Rr3 and Rr4 of 280,000 mm, 20,000 mm, 2,600 mm and 280,000 mm, respectively, formed thereon causes the rolling element 4 to move along moving tracks having curvature radii Rw1, Rw2, Rw3 and Rw4 of 9,000 mm, 3,400 mm, 600 mm and 9,000 mm, respectively, through the gap between the convex portions. Subsequently, the rolling surface of the rolling element 4 is superfinished by a superfinishing grindstone 6.

### Example 4

A procedure of machining the rolling surface of the rolling element 4 such that it has an ideal logarithmic shape as shown in FIG. 16 as a crowning will be described below.

The approximation of the ideal logarithmic shape by arcs gave five arcs having curvature radii (Rw1, Rw2, Rw3, Rw4, Rw5) of 4,500 mm, 2,800 mm, 400 mm, 200 mm and 800 mm, respectively. Therefore, there are provided five convex portions such that the moving tracks of the rolling element 4 have curvature radii Rw1, Rw2, Rw3, Rw4 and Rw5 of 4,500 mm, 2,800 mm, 400 mm and 800 mm, respectively, as shown in FIG. 17. Further, a convex portion is provided having a moving track having a curvature radius Rw6 of 4,500 mm such that the rolling element can be finally superfinished at a large radius of curvature to stabilize superfinishing.

The radius of curvature of the convex portions of the driving rollers 2, 3 are determined from the geometrical relationship between the angle of work center and the diameter of the driving rollers 2, 3 and the diameter of the rolling element 4 such that the moving tracks of the rolling element 4 have curvature radii Rw1, Rw2, Rw3, Rw4, Rw5 and Rw6 of 4,500 mm, 2,800 mm, 400 mm, 200 mm, 800 mm and 4,500 mm, respectively. As a result, Rr1, Rr2, Rr3, Re4, Rr5 and Rr6 are determined to be 335,000 mm, 15,000 mm, 1,800 mm, 900 mm, 3,800 mm and 35,000 mm, respectively.

The use of the driving rollers 2, 3 having a plurality of convex portions having curvature radii Rr1, Rr2, Rr3, Rr4, Rr5 and Rr6 of 35,000 mm, 15,000 mm, 1,800 mm, 900 mm, 3,800 mm and 35,000 mm, respectively, formed thereon causes the rolling element 4 to move along moving tracks having curvature radii Rw1, Rw2, Rw3, Rw4, Rw5 and Rw6 of 4,500 mm, 2,800 mm, 400 mm, 200 mm, 800 mm and 4,500 mm, respectively, through the gap between the convex portions. Subsequently, the rolling surface of the rolling element 4 is superfinished by a superfinishing grindstone 6.

### Example 5

When straight-shaped driving rollers are set at a through-feed angle, the gap between the two rollers is narrowest at the center thereof and widest at the both ends thereof due to the through-feed angle as generally known. Therefore, the work center is highest at the center thereof and lowest at the both ends thereof. In other words, the path of the work has a convex shape. When the work is superfinished with a grindstone pressed thereon under these conditions, the resulting form is determined by the path of the work, which is convex shape, instead of straight shape. In order to obtain a shape having larger radii than this convex shape, driving rollers having a somewhat concave shape may be used. Alternatively, the through-feed angle may be somewhat reduced. However, since the through-feed angle has an effect on the rotary speed of the work and the productivity, the shape of the driving rollers is not limited to convex but may include straight shape and somewhat concave shape if it is desired to obtain a desired shape for a specific through-feed angle.

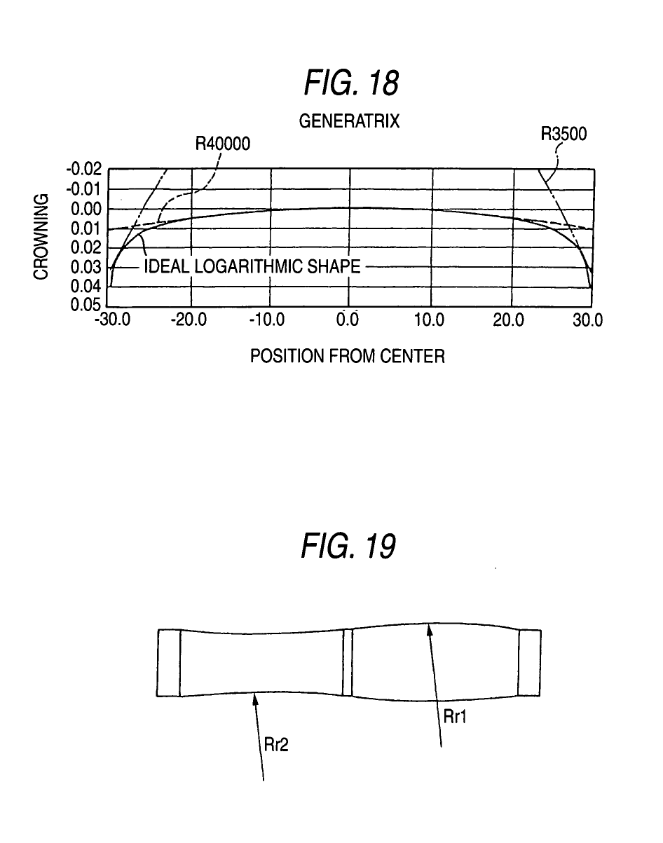

A procedure of machining the rolling surface of the rolling element 4 such that it has an ideal logarithmic shape as shown in FIG. 18 as a crowning using driving rollers having convex portions as well as concave portions as contact portions will be described below.

The approximation of the ideal logarithmic shape by arcs gave two arcs having curvature radii (Rw1, Rw2) of 3,500 mm and 40,000 mm, respectively. Therefore, there are provided a convex portion and a concave portion such that the moving tracks of the rolling element 4 have curvature radii Rw1 and Rw2 of 3,500 mm and 40,000 mm, respectively, as shown in FIG. 19.

The radius of curvature of the convex portion and concave portion of the driving rollers 2, 3 are determined from the geometrical relationship between the angle of work center and the diameter of the driving rollers 2, 3 and the diameter of the rolling element 4 such that the moving tracks of the rolling element 4 have curvature radii Rw1 and Rw2 of 3,500 mm and 40,000 mm, respectively. As a result, the curvature radius Rr1 of the convex portion of the driving rollers 2, 3 and the curvature radius Rr2 of the concave portion of the driving rollers 2, 3 are determined to be 20,000 mm and 90,000 mm, respectively.

The use of the driving rollers 2, 3 having a convex portion and a concave portion having curvature radii Rr1 and Rr2 of 20,000 mm and 90,000 mm, respectively, formed thereon causes the rolling element 4 to move along moving tracks having curvature radii Rw1 and Rw2 of 3,500 mm and 40,000 mm, respectively, through the gap between the convex portion and the concave portion. Subsequently, the rolling surface of the rolling element 4 is superfinished by a superfinishing grindstone 6.

As mentioned above, in accordance with the invention, the work is moved along the contour of the aforementioned contact portions with a superfinishing grindstone pressed on the periphery thereof to superfinish the periphery thereof, making it possible to form a work having a crowning allowing continuous change of radius of curvature. Thus, a rolling element having a long life so as to resist against a wider range of load can be obtained.

What is claimed is:

1. A superfinishing machine comprising:
a pair of driving rollers disposed in parallel to each other which rotate in the same direction to rotate a columnar work fed into the gap therebetween, and
a superfinishing grindstone which is pressed on the work being rotated by the driving rollers from above for superfinishing the periphery of the work with the superfinishing grindstone, wherein
the pair of driving rollers each have a plurality of axially continuous contact portions having different contours of axially taken section provided at opposing positions, and
the work is superfinished on the periphery thereof while being moved along the contact portions with the superfinishing grindstone pressed on the periphery of the work.

2. The superfinishing machine as defined in claim 1, wherein the contour of axially taken section of the plurality of contact portions have different radii of curvature.

3. The superfinishing method performing the superfinishing of the periphery of the work by a superfinishing machine as defined in claim 1.

4. The superfinishing method as defined in claim 3, wherein
the work of which the peripheral generatrix is previously worked in a straight form is superfinished.

5. The superfinishing method as defined in claim 3, wherein
the work of which the peripheral generatrix is previously worked in a crown form is superfinished.

6. The columnar work having a periphery susperfinished by a superfinishing method as defined in claim 3.

7. The rolling element having a rolling surface superfinished by a superfinishing method as defined in claim 3.

8. A superfinishing method for superfinishing the periphery of a columnar work with a superfinishing grindstone pressed on the periphery of the work while rotating the work,
the superfinishing method comprising the steps of:
moving the work along tracks having different radii of curvature while being rotated, and
pressing the superfinishing grindstone on the work during the movement to form arcs having different radii of curvature on the periphery thereof.

9. The rolling element having a curve approximated by arcs having different radii of curvature formed on the rolling surface thereof by a superfinishing method as defined in claim 8, the curve having a continuous and gradual change over connections.

10. The rolling bearing comprising: a rolling element as defined in claim 7 incorporated between an inner ring and an outer ring.

11. The rolling bearing comprising: a rolling element as defined in claim 9 incorporated between an inner ring and an outer ring.
